(19) United States
(12) Patent Application Publication
(10) Pub. No.: US 2024/0365163 A1
(43) Pub. Date: Oct. 31, 2024

(54) METRICS AND MEASUREMENTS AS NETWORK QOS ABSTRACTIONS

(71) Applicant: Telefonaktiebolaget LM Ericsson (publ), Stockholm (SE)

(72) Inventors: Ananya MUDDUKRISHNA, Enskededalen (SE); Dhruvin PATEL, Aachen (DE); Yufei BLANKENSHIP, Kildeer, IL (US); Fedor CHERNOGOROV, Espoo (FI)

(21) Appl. No.: 18/577,536

(22) PCT Filed: Jul. 15, 2021
(86) PCT No.: PCT/SE2021/050732

§ 371 Date: Jan. 8, 2024

(51) Int. Cl. H04W 28/02

(52) U.S. Cl. CPC H04W 28/0268; H04W 28/0215; H04W 28/0236

(57) ABSTRACT

A method performed by a network node for handling a Quality of Service (Qos) configuration request related to a wireless device. The wireless device communicates using a first QoS configuration. The network node receives from the wireless device, sensor data and a first performance indicator related to the sensor data. The network node determines a preferred QoS configuration for the wireless device. The network node transmits to a control unit, a first indication of the preferred QoS. In response to the transmitted first indication, the network node receives a response indicative of a second QoS configuration for the wireless device. Based on the indicated second QoS configuration and the received sensor data, the network node predicts a second performance of the wireless device and transmits to the wireless device, a second performance indicator that indicates the predicted second performance.

### TECHNICAL FIELD

Embodiments herein relate to a wireless device, a network node and methods therein. Furthermore, a computer program and a computer readable storage medium are also provided herein. In particular, embodiments herein relate to handling a Quality of Service (QOS) configuration request related to the wireless device.

### BACKGROUND

In a typical wireless communications network, wireless devices, also known as wireless communication devices, mobile stations, stations (STA) and/or User Equipments (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

Due to high capacity in wireless communication systems wireless communications system are sometimes used for transmission of sensor data. This may be exemplified by FIG. 1, where a robot transmits sensor data to a Planner. Sensor data may relate to a sensor measuring the robot's surrounding environment, e.g. and may comprise what objects are present, how the robot moves, etc. The planner will then assess the received sensor data, e.g. perform sensor fusion to derive insights about the robot's environment, estimate the state of the robot, and plan the robot's further actions, e.g. where and how to move the robot, and then send back trajectory data to the robot. However, in some cases, the robot may require different QoS for communication of some sensor data or trajectory data. The QoS may need to change over time and may be dependent on the current performance of the robot and may be determined based on the measured sensor data. This is illustrated in FIG. 2. To achieve sufficient communication capabilities in relation to the performance needed for transmission of various sensor data or trajectory data, the robot can request a QoS change from a Network Exposure Function (NEF) illustrated in FIG. 2 by sending a specific required 5G QoS Identifier (5QI) to the NEF. The NEF will then respond with the 5QI that will be provided for the sensor data and/or trajectory data.

### SUMMARY

As a part of developing embodiments herein a problem was first identified and will be discussed herein.

QoS abstractions in 5G Systems (5GS) are network-centric and is inconvenient to use by Information Technology (IT) and Operational Technology (OT) programmers who are well-versed in their respective domains but not in the networking technology domain. For example, OT and/or IT programmers are required to map and remap Internet Protocol (IP) flows of applications to certain QoS configurations, e.g. 5QI. This may be performed using a NEF Application Programming Interface (API). Due to the programmers having to specify the QoS explicitly, the programmers need to be informed of which required network-centric QoS configuration is necessary for a specific application, context and/or use-case, e.g. which may be indicated in a Service Level Agreement (SLA).

Since it is difficult to know which QoS configuration is sufficient and/or optimal, these are selected manually, and determined using expert knowledge. Whenever a system change happens, e.g. a network change, an application update etc., the QoS configurations need to be updated, requiring the same expert knowledge and manual selection and therefore the solution is not scalable.

Certain applications may also have varied QoS requirements throughout execution. These applications typically need to request updates to their QoS configuration based on the scenarios they find themselves in. For example, a Simultaneous Localization and Mapping (SLAM) application based on Red, Green, Blue (RGB), and RGB-Depth (RGB-D) cameras requires a higher QoS when entering a zone with dynamic obstacles or low light, and requires a lower QoS when navigating a well-known and well-lit area with no dynamic obstacles. Such QoS dynamicity requires applications to intimately understand how the execution of the application maps to different QoS configurations. This becomes a challenge if the application enters unknown application scenarios.

Converting application execution knowledge to a certain QoS configuration has been tried in very basic and restricted ways. For example, some 5G systems support conversion of Differentiated Services Code Point (DSCP) marking to 5QIs using predefined tables. Furthermore, a recent demonstration of the Zero Touch project, Niemöller et al. in “Cognitive processes for adaptive intent-based networking”, November 2020, demonstrates how to convert Quality-of-Experience (QoE) metrics of human-centric applications to 5QIs. However, all of these solutions are coarse grained and/or not transferable to networking applications, such as e.g. robotics applications, and/or require a lot of in-depth knowledge of networking and/or application domains which thus implies that a high effort is required to select a proper QoS configuration. Furthermore, these approaches are not able to select an optimal QoS configuration with respect to the resources available in the current network. For example, each application and/or communication type may try to get as high QoS as possible to improve their individual performance, and will not consider other applications or communication types operating concurrently. In this way, a wrong QoS configuration will be selected, and thus, the performance of the entire wireless communications network will be affected negatively as unnecessary resources are consumed.

An object of embodiments herein is to improve the performance of a wireless communications network.

According to an aspect of embodiments herein, the object is achieved by a method performed by a network node for handling a QoS configuration request related to a wireless device. The wireless device communicates using a first QoS configuration in a wireless communications network. The network node receives from the wireless device, sensor data and a first performance indicator related to the sensor data. Based on the received sensor data and the first performance indicator, the network node determines a preferred QoS configuration for the wireless device. The network node transmits to a control unit, a first indication of the preferred QoS configuration for the wireless device. In response to the transmitted first indication, the network node receives from the control unit, a response indicative of a second QoS configuration for the wireless device. Based on the indicated second QoS configuration and the received sensor data, the network node predicts a second performance of the wireless device when applying the second QoS configuration for the wireless device. The network node transmits to the wireless device, a second performance indicator. The second performance indicator indicates the predicted second performance.

According to another aspect of embodiments herein, the object is achieved by a method performed by a wireless device for handling a QoS configuration request related to the wireless device. The wireless device communicates using a first QoS configuration in a wireless communications network. The wireless device obtains sensor data and a first performance indicator related to the sensor data. The wireless device transmits to a network node, the sensor data and the first performance indicator. The wireless device receives from the network node, a second performance indicator. The second performance indicator indicates a performance of the wireless device when applying a second QoS configuration for the wireless device. Based on the first and second performance indicators, the wireless device determines how to operate the wireless device.

According to another aspect of embodiments herein, the object is achieved by a network node configured to handle a QoS configuration request related to a wireless device. The wireless device is arranged to communicate using a first QoS configuration in a wireless communications network. The network node is further configured to receive from the wireless device, sensor data and a first performance indicator related to the sensor data. The network node is further configured to, based on the received sensor data and the first performance indicator, determine a preferred QoS configuration for the wireless device. The network node is further configured to transmit to a control unit, a first indication of the preferred QoS configuration for the wireless device. The network node is further configured to, in response to the transmitted first indication, receive from the control unit, a response indicative of a second QoS configuration for the wireless device. The network node is further configured to, based on the indicated second QoS configuration and the received sensor data, predict a second performance of the wireless device when applying the second QoS configuration for the wireless device. The network node is further configured to transmit to the wireless device, a second performance indicator. The second performance indicator is adapted to indicate the predicted second performance.

According to another aspect of embodiments herein, the object is achieved by a wireless device configured to handle a QoS configuration request related to the wireless device. The wireless device communicates using a first QoS configuration in a wireless communications network. The wireless device is further configured to obtain sensor data and a first performance indicator related to the sensor data. The wireless device is further configured to transmit to a network node, the sensor data and the first performance indicator. The wireless device is further configured to receive from the network node, a second performance indicator. The second performance indicator is adapted to indicate a performance of the wireless device when applying a second QoS configuration for the wireless device. The wireless device is further configured to, based on the first and second performance indicators, determine how to operate the wireless device.

It is furthermore provided herein a computer program comprising instructions, which, when executed on at least one processor, cause the at least one processor to carry out any of the methods above, as performed by the network node or the wireless device, respectively. It is additionally provided herein a computer-readable storage medium, having stored thereon a computer program comprising instructions which, when executed on at least one processor, cause the at least one processor to carry out the method according to any of the methods above, as performed by the network node or the wireless device, respectively.

Since the network node receives a first performance indicator and sensor data from the wireless device, the network node determines the preferred QoS configuration for the wireless device. In this way, the wireless device is relieved of determining QoS configurations when optimizing its behavior. Furthermore, since the network node transmits a second performance indicator indicating a performance of the wireless device when applying the second QoS, the wireless device is now enabled to learn which performance to expect when a QoS configuration changes to the second QoS configuration. Using the knowledge of the second performance, and based on the first performance indicator, the wireless device determines how to operate the wireless device. Due to the knowledge of the second performance and the first performance indicator, the wireless device is now capable of determining a more efficient manner of operating the wireless device. This in its turn leads to that the performance of the wireless communications network is improved.

### BRIEF DESCRIPTION OF THE DRAWINGS

Examples of embodiments herein are described in more detail with reference to attached drawings in which:

FIG. 1 is a schematic block diagram illustrating prior art.

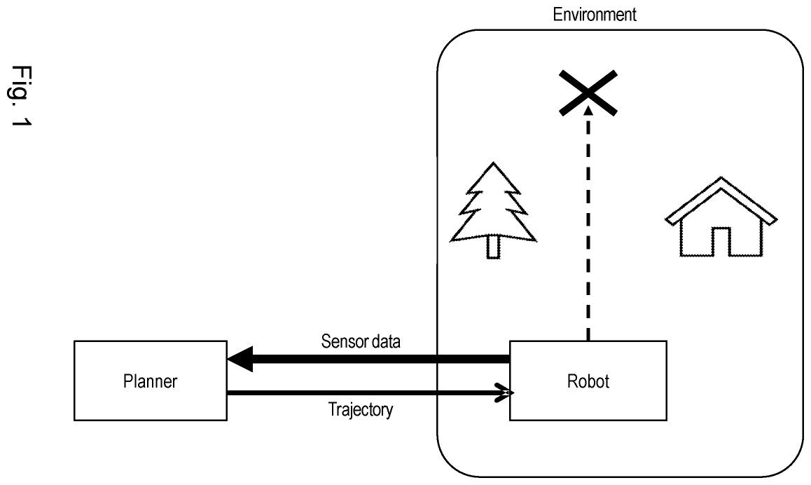

FIG. 2 is a schematic block diagrams illustrating prior art.

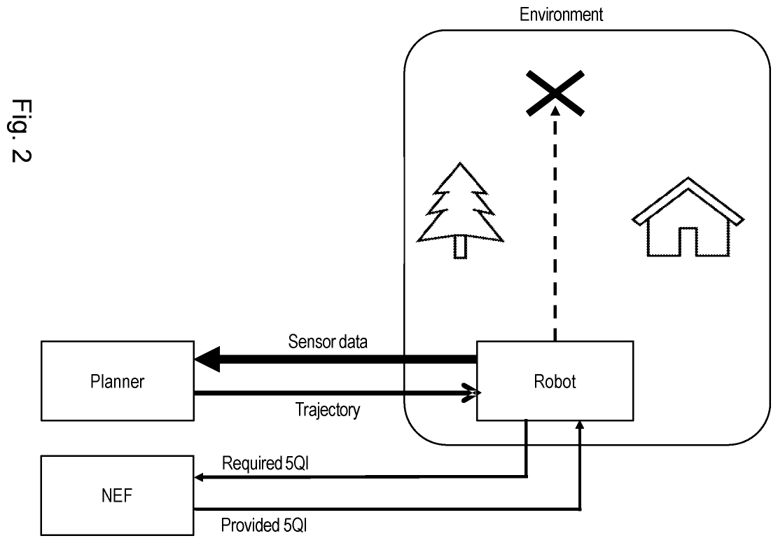

FIG. 3 is a schematic block diagram illustrating embodiments of a wireless communications network.

FIG. 4 is a flowchart depicting an embodiment of a method in a wireless device.

FIG. 5 is a flowchart depicting an embodiment of a method in a network node.

FIG. 6 is a schematic block diagram illustrating embodiments herein.

FIG. 7 is a combined sequence diagram and flowchart illustrating embodiments herein.

FIGS. 8a-b are schematic block diagrams illustrating embodiments of a wireless device.

FIGS. 9a-b are schematic block diagrams illustrating embodiments of a network node.

### DETAILED DESCRIPTION

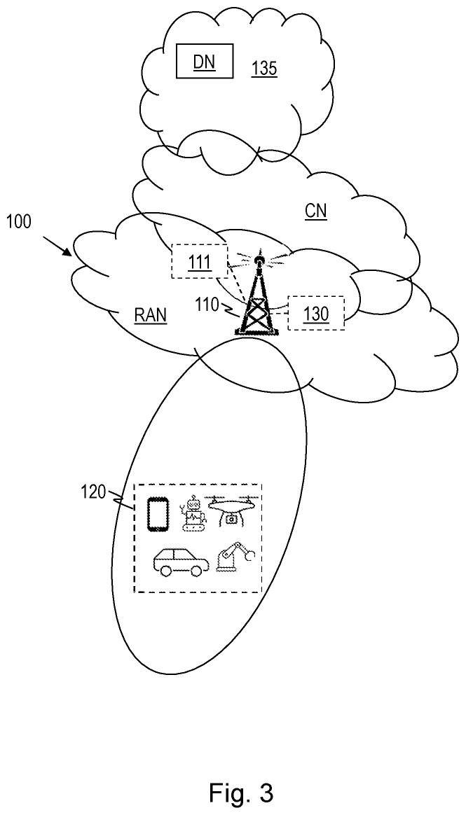

FIG. 3 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMAX), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the wireless communications network 100 such as e.g. a network node 110. The network node 110 may provide radio coverage in a cell, e.g. to a wireless device 120. The network node 110 may be any of a NG-RAN node, a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a wireless device within the service area served by the network node 110. The network node 110 may be referred to as a serving radio network node and communicates with the wireless device 120 with Downlink (DL) transmissions to the wireless device 120 and Uplink (UL) transmissions from the wireless device 120. The network node 110 may further be in communication with a planning node 130. In some embodiments, the planning node 130 is comprised in the network node 110, e.g. operating as a part of the network node 110. In some embodiments the network node 110 is an Application Function (AF), e.g. operating in a core network.

In the wireless communications network 100, one or more wireless devices operate, such as e.g. the wireless device 120. The wireless device 120 may also be referred to as a UE, an internet of things (IoT) device, a mobile station, a non-access point (non-AP) STA, a STA, and/or a wireless terminal. The wireless device 120 communicates via one or more Access Networks (AN), e.g. RAN, to one or more Core Networks (CN). It should be understood by the skilled in the art that “wireless device” or UE, is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell. In some embodiments, the wireless device 120 may be one or more out of, a remotely controlled device, a robot, and an unmanned vehicle. The wireless device 120 may comprise a plurality of sensors, e.g. multi-modal sensors, which are associated with a respective sensor data stream, forming a plurality of sensor data streams related to the wireless device 120. The wireless device 120 may be configured to obtain sensor data from the sensor data streams, e.g. continuously, periodically, and/or based on events, etc.

In the wireless communications network 100, one or more planning nodes may operate, such as e.g. the planning node 130. The planning node 130 may be configured to receive sensor data indicative of the plurality of sensor data streams related to the wireless device 120. The planning node 130 is further configured to use the sensor data to plan actions related to the wireless device 120, e.g. to send trajectory data to the wireless device 120, e.g. where the trajectory data may be indicative of, at least partially, how to operate the wireless device 120. In some embodiments, the planning node 130 is co-located with the network node 110, e.g. comprised in the network node 110. In some other embodiments the planning node 130 operate as a separate node in the wireless communications network 100.

In the wireless communications network 100, one or more control units may operate, such as e.g. the control unit 111. The control unit 111 may be configured to receive one or more indications of QoS configurations. A QoS configuration may be for a specific type of communication e.g. for communicating a certain sensor data, and/or for communicating the trajectory data, performance indicators, etc. The control unit 111 may further, based on the received indication, determine a QoS configuration which is to be applied for the wireless device 120. The control unit 111 may thus control the QoS configuration for the wireless device 120. In some embodiments, the control unit 111 is a NEF. In some embodiments, the control unit 111 is co-located with the network node 110, e.g. comprised in the network node 110. In some other embodiments the control unit 111 operate as a separate node in the wireless communications network 100.

Methods herein may be performed by the network node 110 and/or the wireless device 120. As an alternative, a Distributed Node (DN) and functionality, e.g. comprised in a cloud 135 as shown in FIG. 3, may be used for performing or partly performing the methods herein.

A number of embodiments will now be described, some of which may be seen as alternatives, while some may be used in combination.

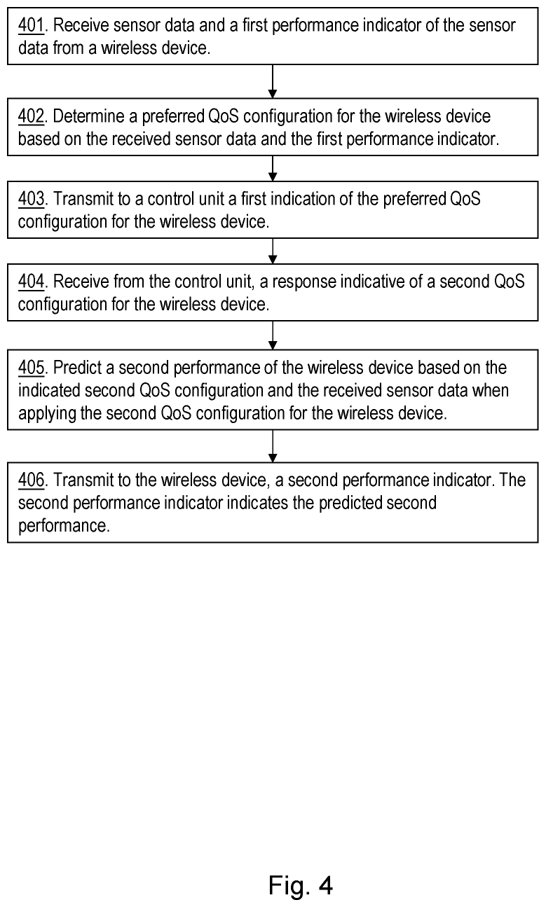

FIG. 4 shows example embodiments of a method performed by the network node 110 for handling a QoS configuration request related to the wireless device 120. The wireless device 120 communicates using a first QoS configuration in the wireless communications network 100.

In below embodiments, the wireless device 120 may be controlled by a planning node 130. The wireless device 120 may further be represented by any one or more out of: a remotely controlled device, a robot, and an unmanned vehicle. The network node 110 may be represented by an AF. The control unit 111 may be represented by a NEF.

The method comprises the following actions, which actions may be taken in any suitable order.

Action 401. The network node 110 receives from the wireless device 120, sensor data and a first performance indicator related to the sensor data. The sensor data may be represented by one or more values, one or more measured values, and/or one or more measurements by a sensor of the wireless device. The first performance indicator may be an indicator of how well an application is performing when executing on the wireless device 120. The first performance indicator may be a custom application performance indicator, e.g. indicating any of: very low performance, low performance, medium performance, high performance, and very high performance. The performance may be with respect to a predefined rule which specifies how to evaluate the performance of the wireless device 120.

In some embodiments, the first performance indicator may be relative to, or comparable to a sufficient performance of the wireless device 120. The sufficient performance may be known and/or determined by the network node 110 and/or the wireless device 120. In some embodiments, the sufficient performance is determined based on the sensor data, e.g. by (1) analysing simulations of the wireless device 120 in an environment with characteristics corresponding to the sensor data and/or (2) by analysing correlations between historical sensor data and historical performance indicators obtained by wireless device 120 and one or more wireless devices similar to wireless device 120. In this context, the similar devices are assumed to be wireless devices operating within the same or similar context, e.g. comparable sensor data and comparable networking infrastructure.

The sufficient performance may be a performance needed to operate the wireless device 120. The sufficient performance may be predefined or determined dynamically.

In some embodiments, when receiving the sensor data and the first performance indicator, the network node 110 further receives at least one condition to be fulfilled. This may e.g. relate to a minimum safety distance when moving in an environment with obstacles some of which may be dynamic others static in the planned trajectory. The condition may be a constraint. In other words, the network node 110 is informed of how to prioritize the QoS configuration such that the performance will at least fulfill the condition.

In some embodiments, the network node 110 further receives a test indication. The test indication indicates that the second QoS configuration shall not be applied for the wireless device 120. Hence, in these embodiments, the test indication allows for the QoS configuration to be tested without being applied, e.g. to evaluate what performance and/or QoS configuration may be delivered based on the sensor data.

Action 402. Based on the received sensor data and the first performance indicator, the network node 110 determines a preferred QoS configuration for the wireless device 120.

In some embodiments, the network node 110 determines the preferred QoS based on the sensor data. This is since when knowing the sensor data, it is possible to determine the quality of the received sensor data, and further, using the quality of the received sensor data, to determine a quality of how well the planner node is capable of planning a trajectory for the wireless device 120.

In some embodiments, the network node 110 determines the preferred QoS based on the sufficient performance of the wireless device 120.

In some embodiments, the network node 110 determines the preferred QoS based on considering a QoS configuration for one or more communication types of the wireless device. The one or more communication types may be any one or more out of: Different types of sensor data from the wireless device 120, trajectory data to the wireless device, and/or performance indicators to and from the wireless device 120. In some of these embodiments, the network node 110 determines the preferred QoS based on a known limitation on one or more network resources. In other words, the network node 110 may determine to evenly give a moderate performance QoS configuration to communication of sensor data and trajectory data since it is not possible to provide high quality QoS for all of the types of communication. For example, if m wireless devices require QoS with guaranteed bit rate, low latency, and high reliability, e.g., 5QI 84, but if current network resources are only adequate to provide such QoS for n<m devices, then the network node 110 may select a QoS with a non-guaranteed bit rate, medium latency, and medium reliability, e.g. 5QI 79, which is possible with the current network resources for all m wireless devices. In other words, the network node 110 may prefer a QoS selection policy which considers all wireless devices in the wireless communications network 100, e.g. a uniform policy instead of non-uniform first-come-first-serve policy.

In some embodiments, the network node 110 determines the preferred QoS configuration based on whether or not a performance lower than the first performance indicator is sufficient for the wireless device 120. In this way, if a lower performance is sufficient for the wireless device 120, it may be possible to reduce network resources and communicate using lower QoS, and still achieve sufficient performance.

In some embodiments the network node 110 determines the preferred QoS configuration for the wireless device 120 by determining that the preferred QoS configuration fulfills the at least one condition when the preferred QoS configuration is applied for the wireless device 120.

Action 403. The network node 110 transmits to the control unit 111 a first indication of the preferred QoS configuration for the wireless device 120.

In some embodiments, the first indication may comprise the preferred QoS configuration. In some embodiments, the first indication is a requested QoS configuration to be applied for the wireless device 120.

The control unit 111 may control the QoS configuration of the wireless device 120. In some embodiments, the control unit 111 is a NEF, which may receive requests for QoS configurations and may further control QoS for the wireless device 120.

In some embodiments, e.g. when the network node 110 has received a test indication, e.g. as discussed in action 401 above, a test indication is sent to the control unit 111, wherein the test indication sent to the control unit 111 indicates to the control unit 111 that no QoS shall be (re) configured for the wireless device 120. In these embodiments, the control unit 111 shall only respond with a response indicative of a second QoS configuration that the control unit 111 would have provided for the wireless device 120, if the second QoS configuration would have been requested. In this way, the network node 110 may query the control unit 111 to learn e.g. which performance indicators and/or which sensor data result in which QoS configurations.

Action 404. In response to the transmitted first indication, the network node 110 receives from the control unit 111, a response indicative of a second QoS configuration for the wireless device 120.

In some embodiments the second QoS configuration is to be applied for the wireless device 120. In some embodiments, e.g. when the network node 110 has received a test indication, the second QoS configuration is a QoS configuration which the control unit would have provided for the wireless device 120, if the second QoS configuration would have been requested.

In some embodiments, any one or more of the preferred QoS configuration and/or the second QoS configuration relates to a QoS configuration of a lower quality than the first QoS configuration. This may be when the network node 110 has determined that the communication works sufficiently well using a lower QoS configuration than the first QoS configuration.

In some embodiments, any one or more of the preferred QoS configuration and/or the second QoS configuration relates to at least one 5QI. In other words, each communication type, e.g. sensor data, trajectory data, and/or performance indicator communicated from and/or to the wireless device may be associated with different 5QI depending on the QoS configuration. The QoS configuration may also relate to 4G QoS Class Identifier (QCI) QoS class indicator and/or a corresponding 6G yet unnamed QoS class and/or quality indicator.

Action 405. Based on the indicated second QoS configuration and the received sensor data, the network node 110 predicts a second performance of the wireless device 120 when applying the second QoS configuration for the wireless device 120.

Predicting the second performance may comprise determining a performance indicator that is to be expected from the wireless device 120 when applying the second QoS configuration.

In some embodiments, the predicted second performance indicator is indicative of a lower performance than the first performance indicator. This may be since the second QoS configuration is lower than the first QoS configuration and thus, the wireless device 120 may operate with lower performance. The performance may still be sufficient, and instead only use less resources than the first performance, i.e. increasing network resource-efficiency.

In some embodiments, predicting the second performance may e.g. be based on any of: (1) analysis of simulations of the wireless device 120 in an environment with characteristics corresponding to the sensor data and/or (2) analysis of correlations between historical sensor data and historical first performance indicators provided by wireless device 120 and one or more devices similar to wireless device 120 and/or (3) use of QoS to performance indicator mappings indicated a-priori e.g., in the SLA.

Action 406. The network node 110 transmits to the wireless device 120, a second performance indicator. The second performance indicator indicates the predicted second performance. For example, the second performance indicator may indicate that using a lower QoS for communicating light intensity information may achieve a medium performance. In this way, the wireless device 120 is informed of which performance to expect from the second QoS configuration.

In some embodiments the second QoS configuration is applied for the wireless device 120.

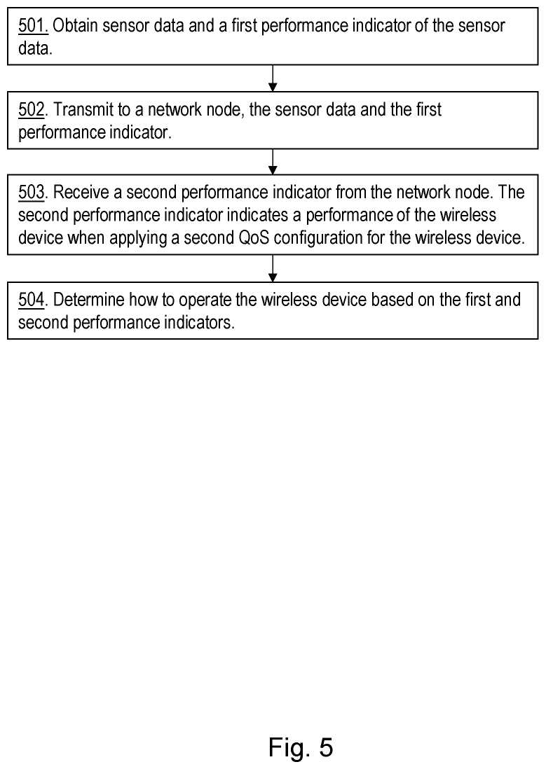

FIG. 5 shows example embodiments of a method performed by the wireless device 120 for handling a QoS configuration request related to the wireless device 120. The wireless device 120 communicates using the first QoS configuration in the wireless communications network 100.

In below embodiments, the wireless device 120 may be controlled by the planning node 130. The wireless device 120 may further be represented by any one or more out of: a remotely controlled device, a robot, and an unmanned vehicle. The network node 110 may be represented by an AF. The control unit 111 may be represented by a NEF.

The method comprises the following actions, which actions may be taken in any suitable order.

Action 501. The wireless device 120, obtains sensor data and a first performance indicator related to the sensor data. The sensor data may be represented by one or more values, one or more measured values, and/or one or more measurements by a sensor of the wireless device. The performance indicator may be an indicator of how well an application is performing when executing on the wireless device 120. The first performance indicator may be a custom application performance indicator, e.g. indicating any of: very low performance, low performance, medium performance, high performance, very high performance.

In some embodiments, the wireless device 120 further obtains at least one condition to be fulfilled. The condition to be fulfilled may e.g. relate to a minimum safety distance when moving in an environment with obstacles some of which may be dynamic others static in the planned trajectory. The condition may be a constraint. In other words, the network node 110 is informed of how to prioritize the QoS configuration such that the performance will at least fulfill the condition.

Action 502. The wireless device 120 transmits to the network node 110, the sensor data and the first performance indicator.

In some embodiments, the wireless device 120 transmits to the network node 110, the at least one condition to be fulfilled. In this way, the network node 110 is enabled to determine the necessary QoS to fulfill the at least one condition.

In some embodiments, the wireless device 120 transmits to the network node 110, the test indication. The test indication indicates that the second QoS configuration shall not be applied for the wireless device 120.

Action 503. The wireless device 120 receives from the network node 110, the second performance indicator. The second performance indicator indicates a performance of the wireless device 120 when applying the second QoS configuration for the wireless device 120.

In some embodiments, the second QoS configuration relates to at least one 5G QoS Identifier (5QI). In other words, each communication type, e.g. sensor data, trajectory data, and/or performance indicator communicated from and/or to the wireless device may be associated with a different 5QI depending on the QoS configuration. The QoS configuration may also relate to 4G QoS Class Identifier (QCI) QoS class indicator and/or a corresponding 6G yet unnamed QoS class and/or quality indicator.

In some embodiments, the second QoS configuration relates to a QoS configuration of a lower quality than the first QoS configuration. This may be when the network node 110 has determined that the communication works sufficiently well using a lower QoS configuration than the first QoS configuration.

In some embodiments, the predicted second performance indicator is indicative of a lower performance than the first performance indicator. This may be since the second QoS configuration is lower than the first QoS configuration and thus, the wireless device 120 may operate using the second QoS configuration with lower performance. The second performance may still be sufficient, and instead only use less resources than the first performance, i.e. increasing network resource-efficiency.

In some embodiments, the second QoS configuration is applied for the wireless device 120.

Action 504. Based on the first and second performance indicators, the wireless device 120, determines how to operate the wireless device 120. Since the wireless device 120 knows at least two performance indicators, i.e. the first and second performance indicators, which may be related to any one or more out of: different locations, states, and/or sensor data, the wireless device 120 may optimize how it operates by considering if the same or better performance may be achieved by reverting its behavior, maintaining its behavior, and/or if there is any benefit in exploring new ways of operating.

In some embodiments, the wireless device 120 determines how to operate the wireless device 120 by determining a trajectory of the wireless device 120. In some embodiments, the wireless device may determine the trajectory based on trajectory data received from the planner node 130.

In some embodiments, the wireless device 120 may determine to operate the wireless device 120 in such a manner that the performance is optimized, e.g. by considering the first and second performance indicator. In some embodiments, a history of performance indicators is stored and may be used to further determine the trajectory of the wireless device. In some embodiments, the wireless device 120 may determine the trajectory of the wireless device e.g. by path planning methods such as A* and/or Time Elastic Bands, e.g. with additional constraints that may encode the first and second performance indicators.

The above embodiments will now be further explained and exemplified below. The embodiments below may be combined with any suitable embodiment above.

Embodiments herein may be performed by an AF, e.g. the network node 110, that converts application metrics and measurements to valid network QoS configurations. The metrics and measurements may be the sensor data, performance indicator and/or conditions mentioned in above actions. The metrics and measurements that may be used may to name a few, e.g. be any one or more out of:
light intensity,
velocity of tracked objects
wheel odometry
sound intensity,
remaining battery energy,
camera and/or Light Detection and Ranging (LiDAR) parameters such as transmission rate, resolution, Field of View (FOV),
time elapsed since last loop closure, e.g. for SLAM applications,
algorithm parameters, e.g. for SLAM applications,
trajectory error, projection error, and/or confusion, e.g. for SLAM applications and/or object recognition, and/or
minimum safety distance.

Conversion to a valid QoS configuration, e.g. determining the preferred QoS configuration and/or receiving the second QoS configuration, in the network node 110 may be performed by indexing the sensor data and/or performance indicators into carefully-designed 5QI tables. In other embodiments the QoS configurations may be determined by a dynamic control system e.g. that selects 5QIs and edge computing schedules, e.g. based on the sensor data and the first performance indicator in the actions above.

Independent of how the conversion is performed, the conversion may tune the performance of the application by degrading or upgrading the network QoS based on the above metrics and/or measurements.

An advantageous effect of embodiments herein is network-controlled application performance. In other words, a more efficient way to control the application performance by the network. In particular, when the wireless device 120 has a sensor data and/or first performance indicator which indicates exceedingly good application performance, then the network node 110 may choose to degrade network QoS and conversely. Performance control of the wireless device 120 thus becomes possible as application metrics and measurements, e.g. related to the applied QoS configuration, are correlated with application performance.

For operating the wireless device 120 in a specialized environment e.g., factory floor, proprietary 5QI values, e.g. instead of, or in addition to, standardized 5QI values, and corresponding service characteristics, e.g., Priority Level, Packet Delay Budget, Packet Error Rate, may be defined to better fit the needs of the wireless device, e.g. based on the metrics and/or measurements shown above. By tracking performance history of the wireless device 120 in the specialized environment, the network node 110 may generate proprietary 5QI values that best capture the needs of applications executing on the wireless device 120 of the specialized environment. The network node 110 may further also update the proprietary 5QI values periodically by checking statistics of the performance history of the wireless device 120, e.g. without human intervention.

Example scenario 1 minimum safety distance. An example scenario (not shown) may relate to conversion of safety distance metric to network QoS configuration. The example scenario relates to a safety distance of moving automated guided vehicles (AGV) on factory shop floor, e.g. in this scenario the wireless device 120. The safety distance may be a minimum distance that should be maintained to an AGV with a human operator, or to any other obstacle, e.g. to avoid collision.

There are certain safety standards which define such minimum hazard distance with formula:

S=(K*T)+C+M, e.g. as defined in IEC TR 62998-2:2020 04, where
S is minimum safety distance, and
K is velocity of the vehicle measured in millimetres per second, and
T is stopping time of overall system, and
C is the additional distance in millimetres that represents the intrusion into the hazard zone before the intrusion detector is triggered, and
M is the measurement uncertainty and represented by tolerance range.

Now with the introduction of the 5G, the safety logic to stop an AGV, e.g. the wireless device 120, are envisioned to be connected via 5G system, e.g. the wireless communications network 100. 5G system latency in uplink and downlink latency naturally affect the T parameter of above equation. This value may further dynamically change with the change in the environment of the factory floor.

With the QoS abstraction, the network node 110 will take input of the minimum safety distance S, e.g. as a condition to be fulfilled as in above actions, and will further determine the preferred QoS configuration, e.g. latency, reliability, and/or edge computing schedule, that may be imposed on the 5G connectivity link. The network node 110 may further determine the preferred QoS configuration which will fulfil the minimum safety distance with respect to the QoS configuration that may affect the above parameters.

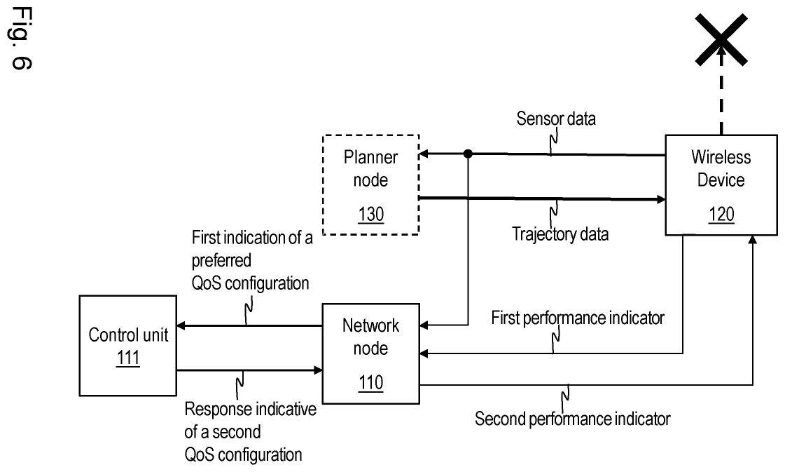

Example scenario 2. Some embodiments herein are illustrated as an example scenario in FIG. 6. The wireless device 120 may be associated with a plurality of sensor data streams. The plurality of sensor data streams may be measured by one or more sensors, e.g. for obtaining sensor data.

The sensor data streams may relate to an environment of the wireless device 120 which e.g. comprise of physical parameters that the wireless device 120 is capable of measuring using the sensors. This may additionally or alternatively be related to a trajectory of how the wireless device is operating, e.g. the wireless device may move towards the X illustrated in FIG. 6.

The wireless device 120 obtains the sensor data and a first performance indicator indicative of a first performance of the wireless device 120. The wireless device 120 transmits the sensor data and the first performance indicator to the network node 110. The sensor data may further be sent to a planner node 130 which may help determine, e.g. plan, the trajectory of the wireless device based on the received sensor data.

The network node 110 may send to the wireless device 120, determine a preferred QoS configuration for the wireless device 120. This may be a QoS configuration which will optimize the performance of the wireless device 120, and/or may cause the wireless device 120 to maintain its performance while using less network resources. In some embodiments, it is preferred to reduce the performance of the wireless device 120. This is since the wireless device 120 may be able to perform its function sufficiently well using low performance, and in this way network resources may be saved, e.g. for other wireless devices in the wireless communications network 100 in need of better performance.

The network node 110 sends to the control unit 111, a first indication of a preferred QoS configuration. The control unit 111 may be a NEF that based on the preferred QoS configuration determines a QoS that will be provided for the wireless device 120. The control unit 111 sends a response to the network node 110 indicative of a second QoS configuration. The network node 110 predicts a second performance of the wireless device when applying the second QoS configuration and notifies the wireless device of the second performance by transmitting a second performance indicator to the wireless device 120.

The wireless device 120 may now know what performance to expect from the second QoS configuration. The wireless device may also receive trajectory data from the planner node 130. Using the knowledge of the first and second performance and the trajectory data planned by the planner node 130, the wireless device 120 may now make an informed decision of how to operate.

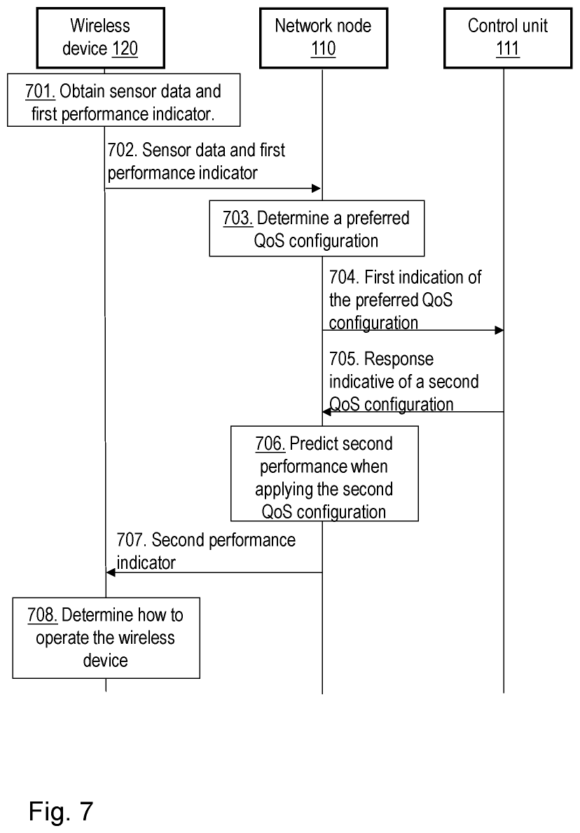

Example scenario 3-Communication overview. An example scenario is illustrated in FIG. 7 which briefly summarizes the communication between the network node 110 and the wireless device 120 and the actions performed, respectively. Below actions may be taken in any suitable order. While illustrated in FIG. 7 as a separate entity, the control unit 111 may also be a part of the network node 110 and thus, communication to and from the control unit 111 may also be performed as internal actions by the network node 110.

Action 701. The wireless device 120 obtains sensor data and first performance indicator. This action may e.g. relate to action 501.

Action 702. The wireless device 120 transmits the sensor data and the first performance indicator to the network node 110. This action may e.g. relate to actions 401 and 502.

Action 703. The network node 110 determines a preferred QoS configuration based on the sensor data and the first performance indicator. This action may e.g. relate to action 402.

Action 704. The network node 110 transmits to the control unit 111, a first indication of the preferred QoS configuration. This action may e.g. relate to action 403.

Action 705. The network node 110 receives from the control unit 111 a response indicative of a second QoS configuration. This action may e.g. relate to action 404.

Action 706. The network node 110 predicts a second performance when applying the second QoS configuration for the wireless device 120. This action may e.g. relate to action 405.

Action 707. The network node 110 transmits a second performance indicator to the wireless device 120. The second performance indicator being indicative of the second performance, e.g. may comprise the second performance. This action may e.g. relate to actions 406 and 503.

Action 708. The wireless device 120 determines how to operate the wireless device 120. This action may e.g. relate to action 504.

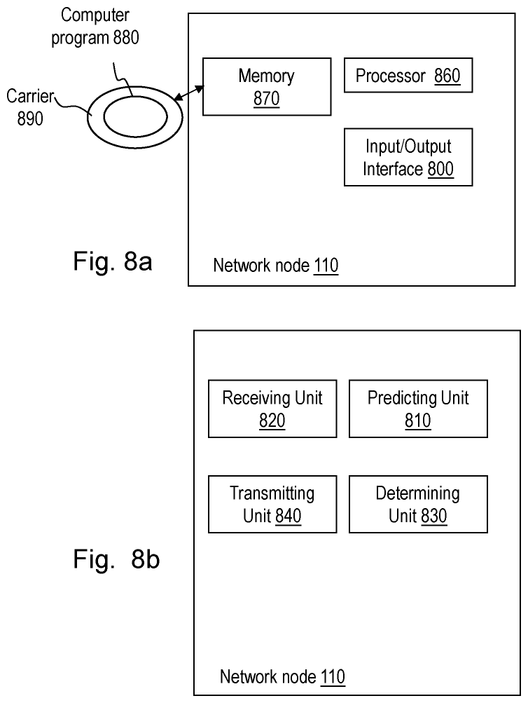

Network node implementation. To perform the method actions above, the network node 110 configured to handle a QoS configuration request related to the wireless device 120. The wireless device 120 is arranged to communicate using a first QoS configuration in a wireless communications network 100. The network node 110 may comprise an arrangement depicted in FIGS. 8a and 8b.

The network node 110 may comprise an input and output interface 800 configured to communicate with the wireless device 120, the control unit 111 and/or the planning node 130. The input and output interface 800 may comprise a wireless receiver (not shown) and a wireless transmitter (not shown).

The network node 110 may further be configured to, e.g. by means of a receiving unit 820 in the network node 110, receive from the wireless device 120, sensor data and a first performance indicator related to the sensor data.

The network node 110 may further be configured to, e.g. by means of the receiving unit 820 in the network node 110, receive at least one condition to be fulfilled.

The network node 110 may further be configured to, e.g. by means of the receiving unit 820 in the network node 110, receive a test indication, wherein the test indication is adapted to indicate that the second QoS configuration shall not be applied for the wireless device 120.

The network node 110 may further be configured to, e.g. by means of a determining unit 830 in the network node 110, based on the received sensor data and the first performance indicator, determine a preferred QoS configuration for the wireless device 120.

The network node 110 may further be configured to, e.g. by means of the determining unit 830 in the network node 110, determine the preferred QoS configuration by determining the preferred QoS based on whether or not a performance lower than the first performance indicator is sufficient for the wireless device 120.

The network node 110 may further be configured to, e.g. by means of the determining unit 830 in the network node 110, determine the preferred QoS configuration for the wireless device 120 by determining that the preferred QoS configuration fulfills the at least one condition when the preferred QoS configuration is applied for the wireless device 120.

The network node 110 may further be configured to, e.g. by means of a transmitting unit 840 in the network node 110, transmit to a control unit 111 a first indication of the preferred QoS configuration for the wireless device 120.

The network node 110 may further be configured to, e.g. by means of the receiving unit 820 in the network node 110, in response to the transmitted first indication, receive from the control unit 111, a response indicative of a second QoS configuration for the wireless device 120.

The network node 110 may further be configured to, e.g. by means of a predicting unit 810 in the network node 110, based on the indicated second QoS configuration and the received sensor data, predict a second performance of the wireless device 120 when applying the second QoS configuration for the wireless device 120.

The network node 110 may further be configured to, e.g. by means of the transmitting unit 840 in the network node 110, transmit to the wireless device 120, a second performance indicator, wherein the second performance indicator is adapted to indicate the predicted second performance.

In some embodiments, any one or more of the preferred QoS configuration and/or the second QoS configuration are adapted to relate to a QoS configuration of a lower quality than the first QoS configuration.

In some embodiments, the predicted second performance indicator is adapted to be indicative of a lower performance than the first performance indicator.

In some embodiments, any one or more of the preferred QoS configuration and/or the second QoS configuration are adapted to relate to at least one 5Q1.

In some embodiments, the second QoS configuration is adapted to be applied for the wireless device 120.

The embodiments herein may be implemented through a respective processor or one or more processors, such as the processor 860 of a processing circuitry in the network node 110 depicted in FIG. 8a, together with respective computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 870 comprising one or more memory units. The memory 870 comprises instructions executable by the processor in network node 110. The memory 870 is arranged to be used to store e.g. information, indications, data, configurations, sensor data, sensor data streams, performance indicators, trajectory data, and applications to perform the methods herein when being executed in the network node 110.

In some embodiments, a computer program 880 comprises instructions, which when executed by the respective at least one processor 860, cause the at least one processor of the network node 110 to perform the actions above.

In some embodiments, a respective carrier 890 comprises the respective computer program 880, wherein the carrier 890 is one of an electronic signal, an optical signal, an electromagnetic signal, a magnetic signal, an electric signal, a radio signal, a microwave signal, or a computer-readable storage medium.

Those skilled in the art will appreciate that the units in the network node 110 described above may refer to a combination of analog and digital circuits, and/or one or more processors configured with software and/or firmware, e.g. stored in the network node 110, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

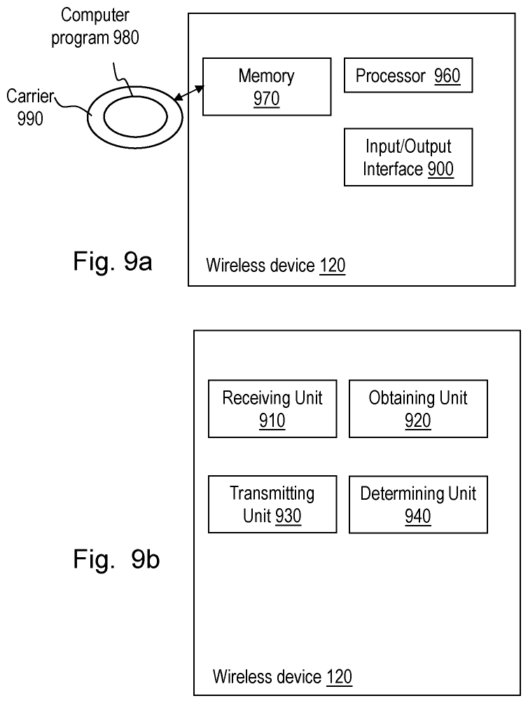

Wireless device implementation. To perform the method actions above, the wireless device 120 is configured to handle a configuration request related to the wireless device 120. The wireless device 120 communicates using a first QoS configuration in a wireless communications network 100. The wireless device 120 may comprise an arrangement depicted in FIGS. 9a and 9b.

The wireless device 120 may comprise an input and output interface 900 configured to communicate with the network node 110 and/or the planning node 130. The input and output interface 900 may comprise a wireless receiver (not shown) and a wireless transmitter (not shown).

The wireless device 120 may further be configured to, e.g. by means of an obtaining unit 920 in the wireless device 120, obtain sensor data and a first performance indicator related to the sensor data.

The wireless device 120 may further be configured to, e.g. by means of the obtaining unit 920 in the wireless device 120, obtain at least one condition to be fulfilled.

The wireless device 120 may further be configured to, e.g. by means of a transmitting unit 930 in the wireless device 120, transmit to a network node 110, the sensor data and the first performance indicator.

The wireless device 120 may further be configured to, e.g. by means of the transmitting unit 930 in the wireless device 120, transmit to the network node 110, the at least one condition to be fulfilled.

The wireless device 120 may further be configured to, e.g. by means of the transmitting unit 930 in the wireless device 120, transmit a test indication, wherein the test indication is adapted to indicate that the second QoS configuration shall not be applied for the wireless device 120.

The wireless device 120 may further be configured to, e.g. by means of a receiving unit 910 in the wireless device 120, receive from the network node 110, a second performance indicator, wherein the second performance indicator is adapted to indicate a performance of the wireless device 120 when applying a second QoS configuration for the wireless device 120.

The wireless device 120 may further be configured to, e.g. by means of a determining unit 940 in the wireless device 120, based on the first and second performance indicators, determine how to operate the wireless device 120.

The wireless device 120 may further be configured to, e.g. by means of the determining unit 940 in the wireless device 120, determine how to operate the wireless device 120 by determining a trajectory of the wireless device 120.

In some embodiments, the second QoS configuration is adapted to relate to a QoS configuration of a lower quality than the first QoS configuration.

In some embodiments, the predicted second performance indicator is adapted to be indicative of a lower performance than the first performance indicator.

In some embodiments, the second QoS configuration is adapted to relate to at least one 5Q1.

In some embodiments, the second QoS configuration is adapted to be applied for the wireless device 120.

In some embodiments, the wireless device 120 is adapted to be represented by any one or more out of:
a remotely controlled device,
a robot, and
an unmanned vehicle.

The embodiments herein may be implemented through a respective processor or one or more processors, such as the processor 960 of a processing circuitry in the wireless device 120 depicted in FIG. 9a, together with respective computer program code for performing the functions and actions of the embodiments herein. The program code mentioned above may also be provided as a computer program product, for instance in the form of a data carrier carrying computer program code for performing the embodiments herein when being loaded into the wireless device 120. One such carrier may be in the form of a CD ROM disc. It is however feasible with other data carriers such as a memory stick. The computer program code may furthermore be provided as pure program code on a server and downloaded to the wireless device 120.

The wireless device 120 may further comprise a memory 970 comprising one or more memory units. The memory 970 comprises instructions executable by the processor in wireless device 120. The memory 970 is arranged to be used to store e.g. information, indications, data, configurations, sensor data, sensor data streams, trajectory data, performance indicators, and applications to perform the methods herein when being executed in the wireless device 120.

In some embodiments, a computer program 980 comprises instructions, which when executed by the respective at least one processor 960, cause the at least one processor of the wireless device 120 to perform the actions above.

In some embodiments, a respective carrier 990 comprises the respective computer program 980, wherein the carrier 990 is one of an electronic signal, an optical signal, an electromagnetic signal, a magnetic signal, an electric signal, a radio signal, a microwave signal, or a computer-readable storage medium.

Those skilled in the art will appreciate that the units in the wireless device 120 described above may refer to a combination of analog and digital circuits, and/or one or more processors configured with software and/or firmware, e.g. stored in the wireless device 120, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method performed by a network node for handling a Quality of Service, QoS, configuration request related to a wireless device, the wireless device communicating using a first QoS configuration in a wireless communications network, the method comprising:
receiving from the wireless device, sensor data and a first performance indicator related to the sensor data,
based on the received sensor data and the first performance indicator, determining a preferred QoS configuration for the wireless device,
transmitting to a control unit a first indication of the preferred QoS configuration for the wireless device,
in response to the transmitted first indication, receiving from the control unit, a response indicative of a second QoS configuration for the wireless device,
based on the indicated second QoS configuration and the received sensor data, predicting a second performance of the wireless device when applying the second QoS configuration for the wireless device, and
transmitting to the wireless device, a second performance indicator, wherein the second performance indicator indicates the predicted second performance.

2. The method according to claim 1, wherein determining the preferred QoS configuration comprises determining the preferred QoS based on whether or not a performance lower than the first performance indicator is sufficient for the wireless device.

3. The method according to claim 1, wherein any one or more of the preferred QoS configuration and/or the second QoS configuration relates to a QoS configuration of a lower quality than the first QoS configuration.

4. The method according to claim 1, wherein the predicted second performance indicator is indicative of a lower performance than the first performance indicator.

5. The method according to claim 1, wherein any one or more of the preferred QoS configuration and/or the second QoS configuration relates to at least one 5G QoS Identifier, 5QI.

6. The method according to claim 1, wherein receiving the sensor data and the first performance indicator further comprises receiving at least one condition to be fulfilled.

7. The method according to claim 6, wherein determining the preferred QoS configuration for the wireless device further comprises determining that the preferred QoS configuration fulfills the at least one condition when the preferred QoS configuration is applied for the wireless device.

8. The method according to claim 1, wherein the second QoS configuration is applied for the wireless device.

9. The method according to claim 1, wherein receiving the sensor data and the first performance indicator further comprises receiving a test indication, wherein the test indication indicates that the second QoS configuration shall not be applied for the wireless device.

10. A method performed by a wireless device for handling a Quality of Service, QoS, configuration request related to the wireless device, the wireless device communicating using a first QoS configuration in a wireless communications network, the method comprising:
obtaining sensor data and a first performance indicator related to the sensor data,
transmitting to a network node, the sensor data and the first performance indicator,
receiving from the network node, a second performance indicator, wherein the second performance indicator indicates a performance of the wireless device when applying a second QoS configuration for the wireless device, and
based on the first and second performance indicators, determining how to operate the wireless device.

11. The method according to claim 10, wherein the second QoS configuration relates to a QoS configuration of a lower quality than the first QoS configuration.

12. The method according to claim 10, wherein the predicted second performance indicator is indicative of a lower performance than the first performance indicator.

13. The method according to claim 10, wherein the second QoS configuration relates to at least one 5G QoS Identifier, 5QI.

14. The method according to claim 10, wherein obtaining the sensor data and the first performance indicator further comprises obtaining at least one condition to be fulfilled, and wherein transmitting to the network node, the sensor data and the first performance indicator further comprises transmitting the at least one condition to be fulfilled.

15. The method according to claim 10, wherein the second QoS configuration is applied for the wireless device.

16. The method according to claim 10, wherein transmitting to the network node, the sensor data and the first performance indicator further comprises transmitting a test indication, wherein the test indication indicates that the second QoS configuration shall not be applied for the wireless device.

17. The method according to claim 10, wherein the wireless device is represented by any one out of:
a remotely controlled device,
a robot, and
an unmanned vehicle,
and wherein determining how to operate the wireless device further comprises determining a trajectory of the wireless device.

18.-21. (canceled)

22. A network node configured to handle a Quality of Service, QoS, configuration request related to a wireless device, the wireless device being configured to communicate using a first QoS configuration in a wireless communications network, the network node further being configured to:
receive from the wireless device, sensor data and a first performance indicator related to the sensor data,
based on the received sensor data and the first performance indicator, determine a preferred QoS configuration for the wireless device,
transmit to a control unit a first indication of the preferred QoS configuration for the wireless device,
in response to the transmitted first indication, receive from the control unit, a response indicative of a second QoS configuration for the wireless device,
based on the indicated second QoS configuration and the received sensor data, predict a second performance of the wireless device when applying the second QoS configuration for the wireless device,
transmit to the wireless device, a second performance indicator, wherein the second performance indicator is adapted to indicate the predicted second performance.

23. The network node according to claim 22, further configured to determine the preferred QoS configuration by determining the preferred QoS based on whether or not a performance lower than the first performance indicator is sufficient for the wireless device.

24.-30. (canceled)

31. A wireless device configured to handle a Quality of Service, QoS, configuration request related to the wireless device, the wireless device communicating using a first QoS configuration in a wireless communications network, the wireless device further being configured to:
obtain sensor data and a first performance indicator related to the sensor data,
transmit to a network node, the sensor data and the first performance indicator,
receive from the network node, a second performance indicator, wherein the second performance indicator is adapted to indicate a performance of the wireless device when applying a second QoS configuration for the wireless device, and
based on the first and second performance indicators, determine how to operate the wireless device.

32.-38. (canceled)
